(19) United States
(12) Patent Application Publication
(10) Pub. No.: US 2020/0253236 A1
(43) Pub. Date: Aug. 13, 2020

(54) SHAPED FOOD PRODUCT

(71) Applicant: Ruby Schechter, New York, NY (US)

(72) Inventor: Ruby Schechter, New York, NY (US)

(21) Appl. No.: 16/793,176

(22) Filed: Feb. 18, 2020

Related U.S. Application Data
(63) Continuation-in-part of application No. 29/672,095, filed on Dec. 3, 2018, now Pat. No. D879407.

(51) Int. Cl. A23G 9/22; A23G 9/50

(52) U.S. Cl. CPC A23G 9/221; A23G 9/503

(57) ABSTRACT

The invention relates to a shape of a food product designed for a better biting, sharing, and overall eating experience, where each section is easily bitten off, keeping sensitive teeth from hurting, or broken off for sharing. More particularly, the present invention relates to a food product shape that includes a plurality of base units of polyhedrons or curved geometric shapes wherein the connection between the base units provide shearability.

### RELATED APPLICATIONS AND INCORPORATION BY REFERENCE

This application is a continuation-in-part application of U.S. design patent application Ser. No. 29/672,095 filed Dec. 3, 2018.

The foregoing applications, and all documents cited therein or during their prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The present invention relates generally to an apparatus and method for making food products having a plurality of base units of polyhedrons or curved geometric shapes wherein the connection between the base units provide shearability.

### BACKGROUND OF THE INVENTION

Food products are available in a variety of flavors, configurations, sizes, textures, and combinations. For example, the frozen novelty business is a multi-billion dollar industry. The category of better-for-you products is a rapidly growing segment of the overall novelty market. Unfortunately, food that is better-for-you does not necessarily taste good. For example, kombucha is a great source of probiotics, however, the taste of kombucha does not necessarily appeal to everybody. Ice pops are a media to consume kombucha because they generally do not upset stomachs; however, ice pops are disadvantaged in that they are difficult to bite off and share with others.

There is a need for a food product with a shape that allows easy biting and sharing.

Citation or identification of any document in this application is not an admission that such document is available as prior art to the present invention.

### SUMMARY OF THE INVENTION

The present invention relates to a food product with a shape designed for better biting, sharing and overall eating experience where each section is easily bitten off, keeping sensitive teeth from hurting.

The present invention relates to a food product, which may comprise a plurality of base units, wherein a base unit may comprise a polyhedron or a curved geometric shape having a top, a bottom, and a middle, wherein the individual base units are connected on at least one side to another base unit; and the connection between the base units is shearable.

In an embodiment wherein the base unit is a polyhedron, the top may comprise a top pyramid having a plurality of triangular faces and a base having a plurality of sides equal to the number of triangular faces that forms an upper base of a prism; wherein the bottom may comprise a bottom pyramid having a plurality of triangular faces and a base having a plurality of sides equal to the number of triangular faces that forms a lower base of the prism; wherein the middle may comprise the prism having the upper base, the lower base, and a plurality of faces equal to the number of triangular faces of either the top pyramid or the bottom pyramid.

In one embodiment, the top pyramid may comprise six triangular faces, the bottom pyramid may comprise six triangular faces, the upper base of the prism may comprise six sides, the lower base of the prism may comprise six sides, and wherein the prism may comprise six faces. In another embodiment, the polyhedron may be an elongated hexagonal bipyramid. In another embodiment, the width may comprise at least two connected base units. In another embodiment, the length may comprise at least two connected base units. In another embodiment, the width may comprise at least three connected base units and whose length may comprise at least five connected base units.

In an advantageous embodiment, the base units may comprise chocolate, a cookie, fruit, frozen water, frozen yogurt, gelatin, ice cream, kombucha, or a wafer. In another advantageous embodiment, the food product may be a frozen confection, such as but not limited to, an ice pop, freezer pop, ice lolly, ice block, icy pole, ice drop, paleta, or ice cream bar, optionally with a supporting member, such as a stick. In an advantageous embodiment, the kombucha may be flavored or unflavored and optionally mixed with fruit.

The present invention relates to method for obtaining a food product which may comprise the steps of: three-dimensionally printing a mold, which may comprise a plurality of base units at a desired length and a desired width, filling the mold with chocolate, a cookie, fruit, frozen water, frozen yogurt, gelatin, ice cream, kombucha, or a wafer, optionally freezing, chilling, or heating the mold to set the food product, and removing the finished food product from the mold. The method may further comprise the step of inserting the supporting member into the mold prior to the optional step of freezing, chilling, or heating the mold to set the food product. Advantageously, the mold may comprise an upper half and a lower half.

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. § 112, first paragraph) or the EPO (Article 83 of the EPC), such that Applicants reserve the right and hereby disclose a disclaimer of any previously described product, process of making the product, or method of using the product. It may be advantageous in the practice of the invention to be in compliance with Art. 53(c) EPC and Rule 28(b) and (c) EPC. All rights to explicitly disclaim any embodiments that are the subject of any granted patent(s) of applicant in the lineage of this application or in any other lineage or in any prior filed application of any third party is explicitly reserved. Nothing herein is to be construed as a promise.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following detailed description, given by way of example, but not intended to limit the invention solely to the specific embodiments described, may best be understood in conjunction with the accompanying drawings.

FIG. 1 depicts a Rhino file for the 3D printing of half of an ice pop having a polyhedron shape.

FIG. 2 depicts a Rhino file for the 3D printing of ice pop molds having a polyhedron shape.

FIGS. 3A-3F depicts views of an exemplary frozen confection having a polyhedron shape. FIG. 3A depicts a top, front, and right side perspective view, FIG. 3B depicts a front elevation view, FIG. 3C depicts a rear elevation view, FIG. 3D depicts a left side elevation view, FIG. 3E depicts a right side elevation view and FIG. 3F depicts a top plan view.

FIGS. 4A-4D depict a Rhino file for the 3D printing of an ice pop having a curved geometric shape.

FIGS. 5A-5D depict a Rhino file for the 3D printing of an ice pop having a polyhedron shape.

### DETAILED DESCRIPTION OF THE INVENTION

The present invention relates to a food product which may comprise: a plurality of base units, wherein a base unit may comprise a polyhedron or a curved geometric shape having a top, a bottom, and a middle; wherein the individual base units are connected on at least one side to another base unit; and the connection between the base units is shearable.

In an embodiment, wherein the base unit is a polyhedron, the top may comprise a top pyramid having a plurality of triangular faces and a base having a plurality of sides equal to the number of triangular faces that forms an upper base of a prism;

wherein the bottom may comprise a bottom pyramid having a plurality of triangular faces and a base having a plurality of sides equal to the number of triangular faces that forms a lower base of the prism; and

wherein the middle may comprise the prism having the upper base, the lower base, and a plurality of faces equal to the number of triangular faces of either the top pyramid or the bottom pyramid.

In one embodiment, the top pyramid has six triangular faces, the bottom pyramid has six triangular faces, the upper base of the prism has six sides, the lower base of the prism has six sides, and wherein the prism has six faces. In another embodiment, the polyhedron is an elongated hexagonal bipyramid. In another embodiment, the width may comprise at least two connected base units. In another embodiment, the length may comprise at least two connected base units. In another embodiment, the width may comprise at least three connected base units and whose length may comprise at least five connected base units. In another embodiment, the length of the supporting member exceeds the length of the food product.

The distance between the center of the base unit to a side is typically about 1 cm to about 3.5 cm, preferably about 1.5 to 2.5 cm, and more preferably about 1.8 cm to 2.1 cm. The base unit typically has a height of about 0.5 cm to about 2 cm, preferably about 0.8 cm to 1.4 cm, and more preferably about 1 cm to 1.3 cm. The angled base unit sides are typically angled at about 5 degrees to about 15 degrees from perpendicular to the bottom wall, preferably about 7 degrees to 11 degrees.

In another embodiment, the product includes two to six base units, the individual base units being connected on at least one side to another base unit, wherein the connection is shearable between base units to separate the base units for consumption. Preferably, the side that is connected to another base unit is longer than the sides immediately adjacent thereto.

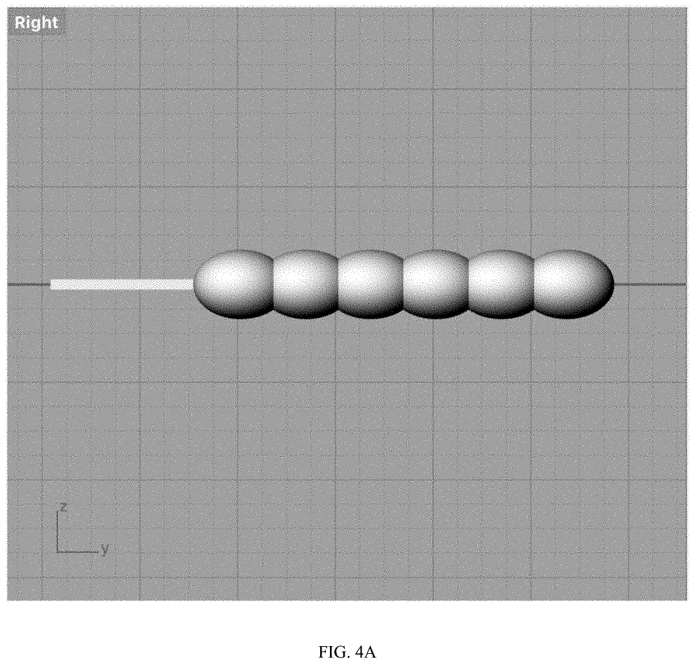

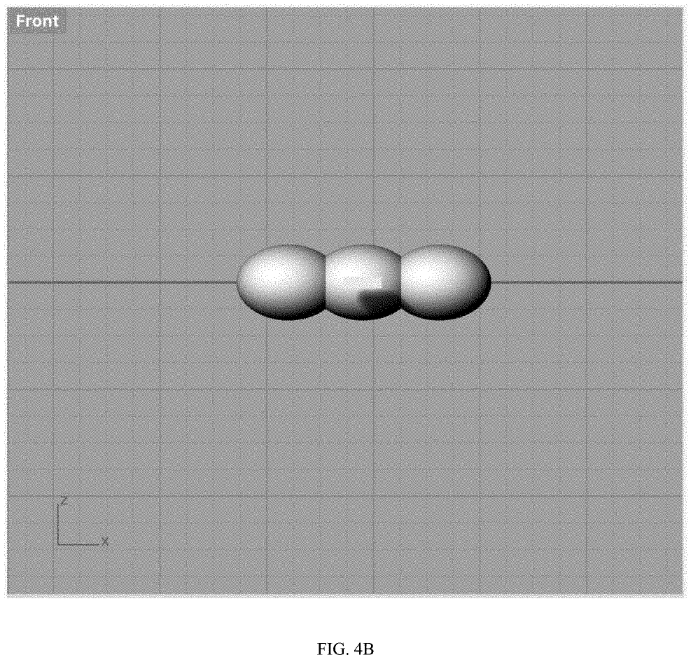

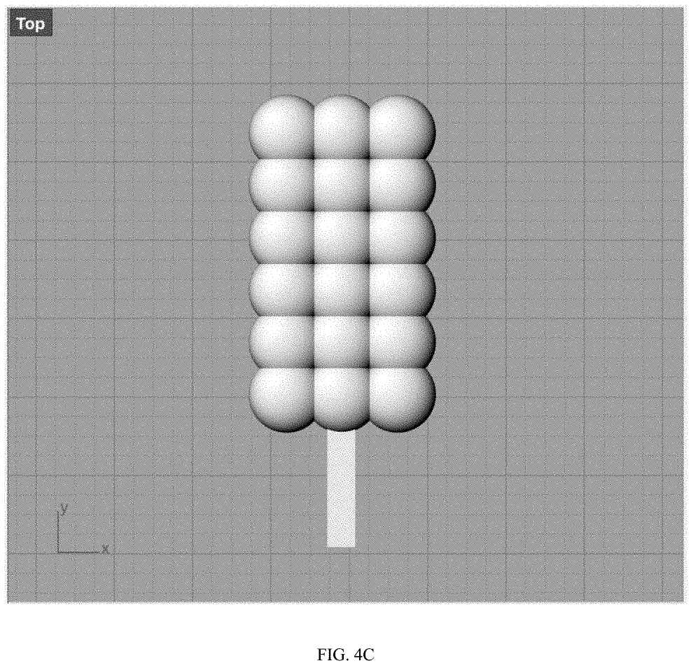

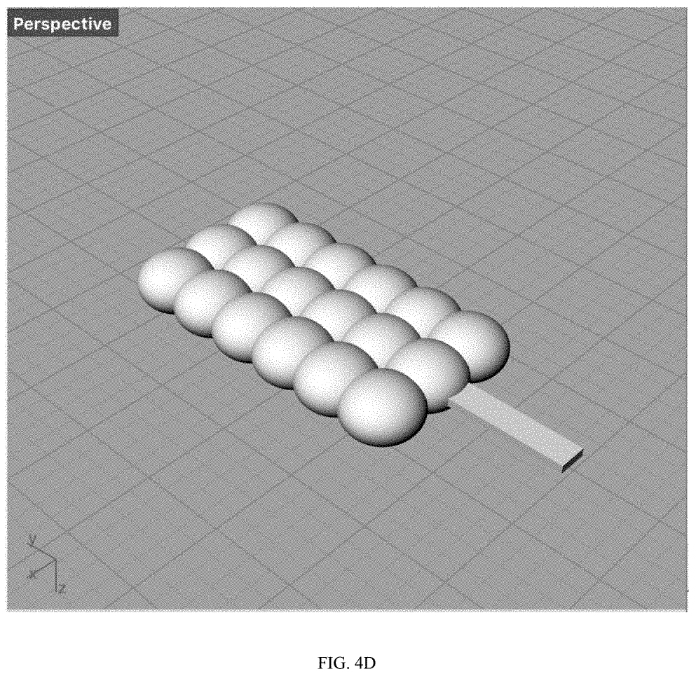

Other shapes are contemplated for the base unit. The base unit shape may be a five to twelve sided figure, where each side when viewed from above is substantially straight. Each side of the base unit may be, but is not necessarily, of the same length as other sides, i.e., a pentagon, hexagon, heptagon, octagon, and the like. The base unit may also have a rounded geometric shape, such as an ovoid or a sphere. See, e.g., FIGS. 4A-4D.

The base units are designed to be bite-sized or to be consumed in several bites, depending both on the consumer and on the size selected. Preferably, the unit should be sized and shaped to be consumed in several bites. The base unit may be about 1 cm to about 3.5 cm in radius, where the radius is defined as the distance between the center of the bar as viewed from above to the closest point of any one side of the base unit. Preferably, the base unit radius may be about 1.5 cm to about 2.5 cm, more preferably about 1.8 cm to about 2.1 cm.

In a preferred embodiment, the distance between the center of the base unit to a side, as viewed from above, is from about 1.8 to about 2.1 cm; the height of the base unit is about 1 to about 1.3 cm; and about 0.7 cm above the top of the base unit.

In one embodiment, the distance between the center of the base unit, as viewed from above, to a side is about 1 cm to about 3.5 cm and the height of the base unit is about 0.5 cm to about 2 cm. The base unit sides may be angled about 5 degrees to about 15 degrees from perpendicular to facilitate removing the product from a mold and to provide visual appeal to the final product.

The height of the base unit, excluding the center inclusion, may be about 0.5 cm to about 2 cm, more preferably about 0.8 cm to about 1.4 cm, most preferably about 1 cm to about 1.3 cm. This height allows the center inclusion to rise above the base unit while still allowing the base unit and to be easily bitten.

At least some of the sides may be angled with respect to the bottom, preferably at an angle of less than 90° from the bottom. All the sides of the base unit may be advantageously angled, for example from about 5 degrees to 15 degrees, preferably at from about 7 degrees to 11 degrees, from a plane that is perpendicular to the bottom. The angle is preferably such that the radius of a base unit at the bottom edge is greater than the radius of a base unit measured at the top edge. This inwardly directed angle allows the confectionery bar to be easily released from the product forming molds and provides visual appeal to the final product.

A plurality of base units can be connected to form a larger food product. The food product so formed is advantageously shearable at the union between adjacent base units. Preferably, three to five base units are fixed together in a single line, more preferably, three to four base units are fixed together in a single line. Of course, two adjacent base units may share a side, or more preferably, additional confectionery may be added to the attaching sides of the adjacent base units to affect the connection between adjacent base units.

The molds of the invention may be printed with a 3-D printer and techniques are known by one of skill in the art. Rhinoceros (typically abbreviated Rhino, or Rhino3D) is a commercial 3D computer graphics and computer-aided design (CAD) application software developed by Robert McNeel & Associates. Rhinoceros geometry is based on the NURBS mathematical model, which focuses on producing mathematically precise representation of curves and freeform surfaces in computer graphics (as opposed to polygon mesh-based applications). Rhinoceros is used in processes of computer-aided design (CAD), computer-aided manufacturing (CAM), rapid prototyping, 3D printing and reverse engineering in industries including architecture, industrial design (e.g. automotive design, watercraft design), product design (e.g. jewelry design) as well as for multimedia and graphic design.

A mold is provided that has the shape of the final product. The mold is typically in the inverse image of the finished product, and is beneficially upside down so that when filled with the food product the top of the food product is the bottom of the product. Generally, the mold may comprise a two part mold that fit together with pins. Pour gates are also contemplated. The mold may be assembled by putting the two parts together and securing with pins. The food product may be poured into the holes of the pour gates. If the food product is an ice pop, a supporting member may be added. The food product is then allowed to solidify. If the food product is a frozen food product, then the mold filled with the food product is frozen. The food product is cooled into the temperature range from about 0° C. to about −30° C.

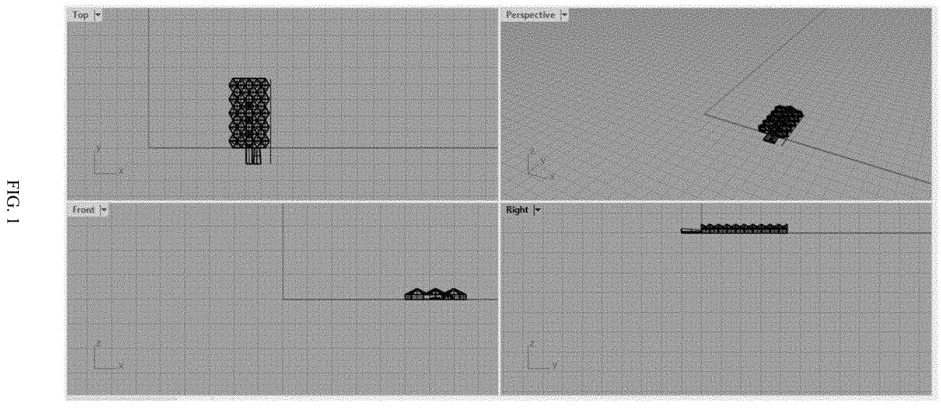

FIG. 1 depicts a Rhino file for the 3D printing of half of an ice pop.

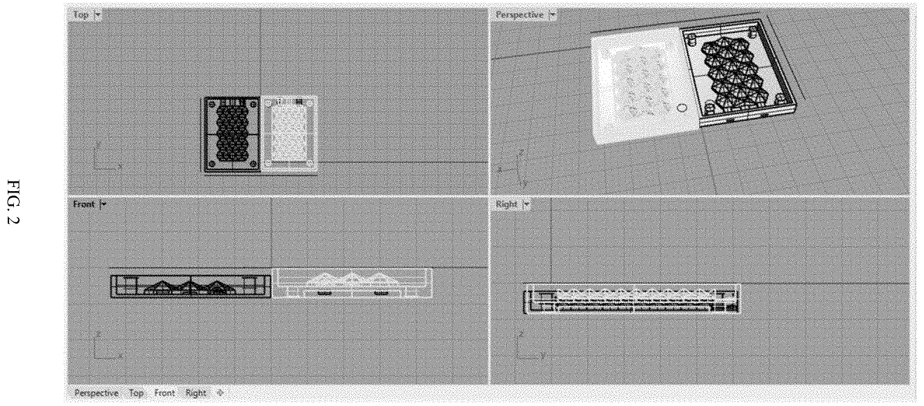

FIG. 2 depicts a Rhino file for the 3D printing of the molds.

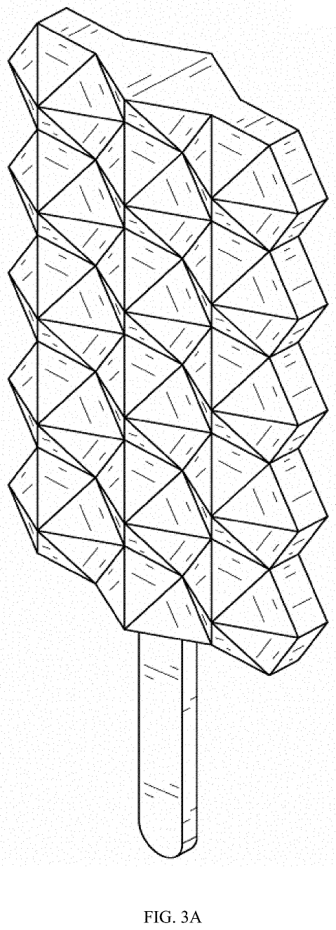

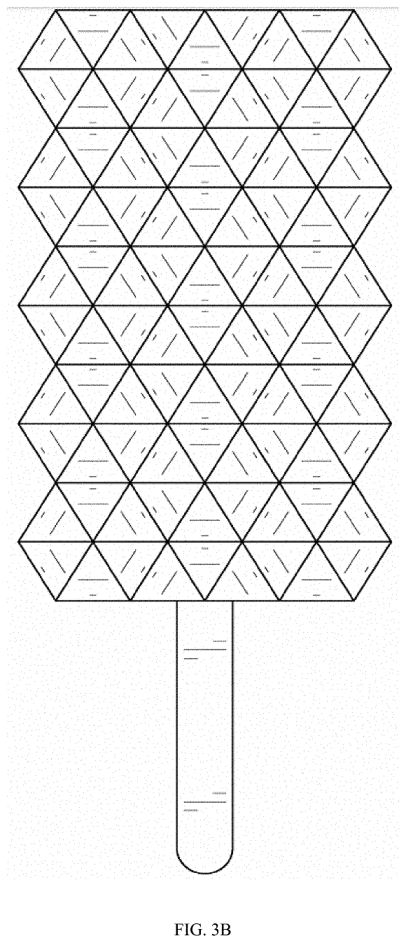

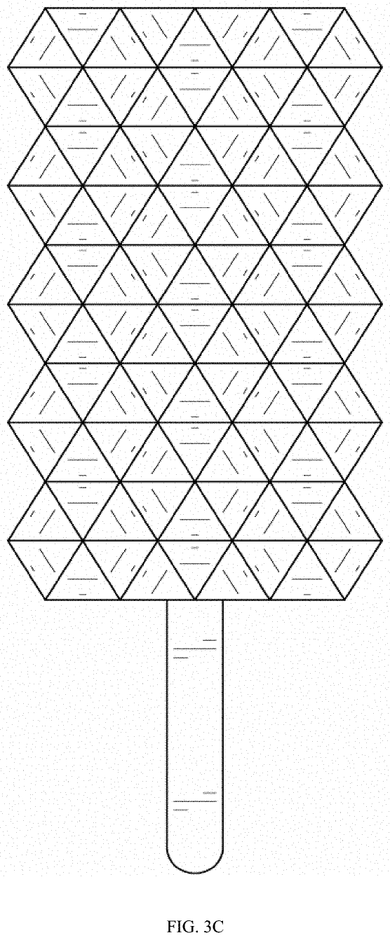

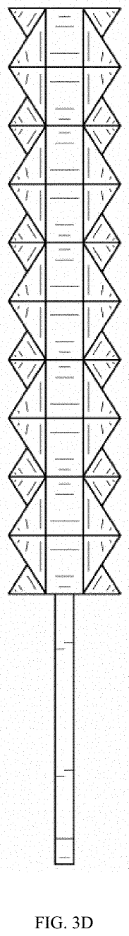

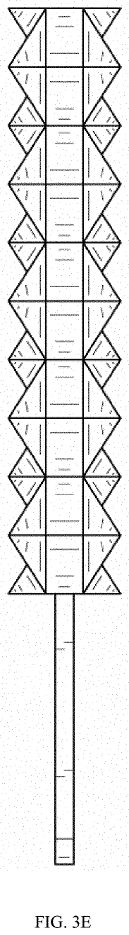

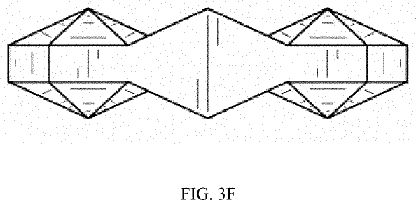

In a particularly advantageous embodiment, the food product may have the shape depicted in FIGS. 3A-3F optionally without the depicted supporting member.

In another embodiment, the food product may have the shape depicted in FIGS. 4A-4D optionally without the depicted supporting member.

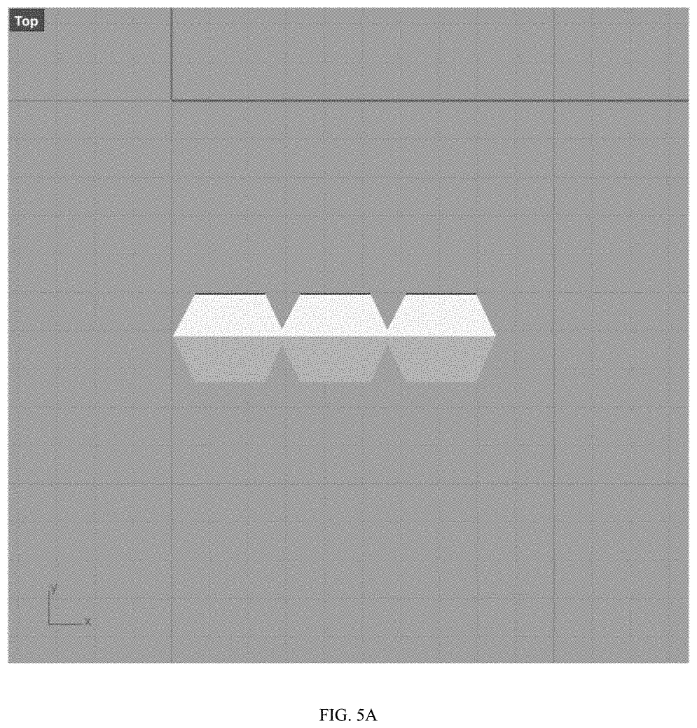

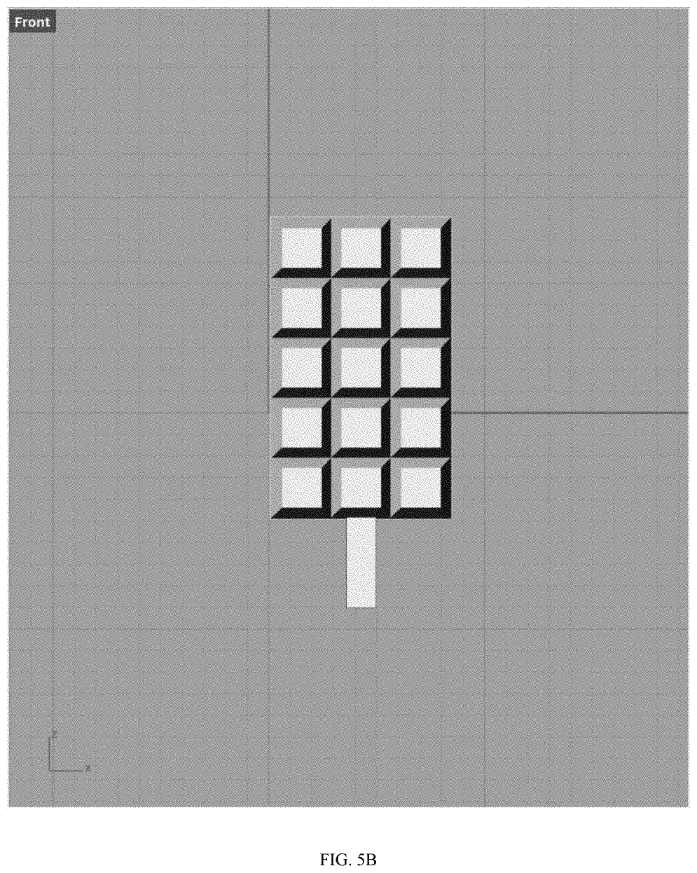

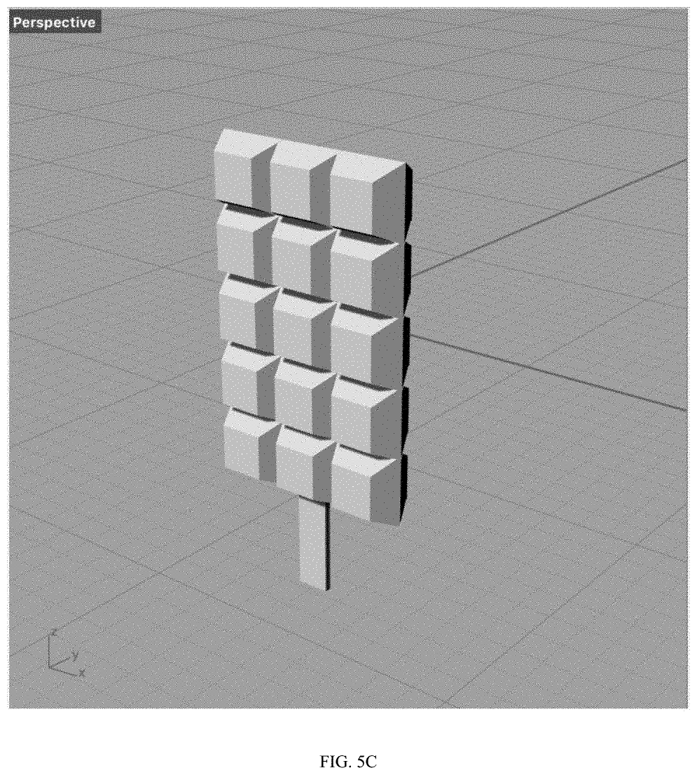

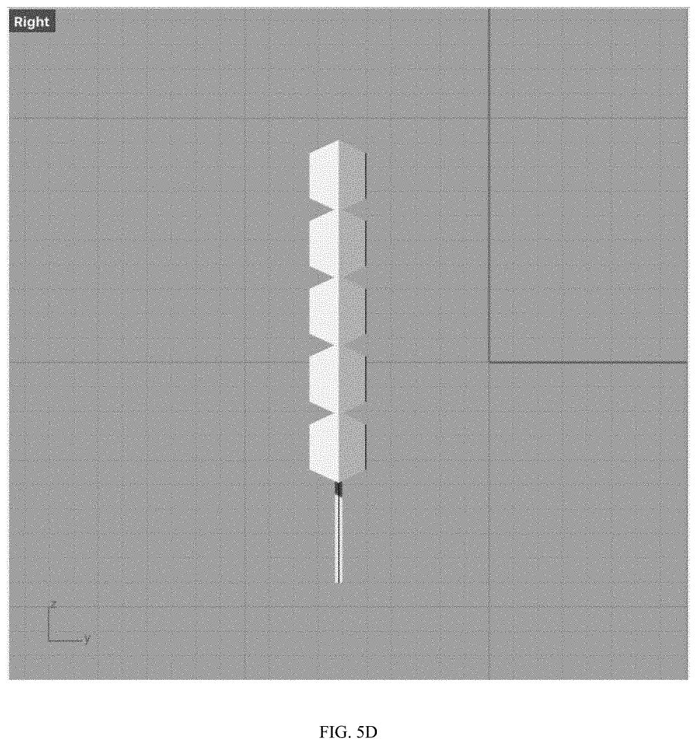

In another embodiment, the food product may be a frozen food product which may have the shape depicted in FIGS. 5A-5D preferably having a supporting member.

In an advantageous embodiment, the base units may comprise chocolate, a cookie, fruit, frozen water, frozen yogurt, gelatin, ice cream, kombucha, or a wafer. In an advantageous embodiment, the kombucha may be flavored or unflavored and optionally mixed with fruit. Additional products that may be frozen in accordance with the present invention include fruit juice concentrates, soy and other sauces, soups, tofu, yogurt, and other such foods, for example fruit and vegetable purees.

Advantageously, the food product may be a frozen confection, such as, but not limited to, an ice pop, freezer pop, ice lolly, ice block, icy pole, ice drop, paleta, ice cream bar, or other frozen treat, optionally on a supporting member, such as a stick. In a particularly advantageous embodiment, the frozen confection may comprise kombucha and fruit. There may be additional ingredients, such as additional liquids, such as fruit juices, creams, milks, coffee, energy drinks, liquor, wine, vitamins, and the like, and spices, such as chili, garlic, ginger, herbs, salt, sumac, or tamarind.

Optionally, the food product may comprise a stabilizer, an emulsifier, and/or additional flavoring.

In general stabilizers improve the stability of a water ice composition before freezing and act as a thickening agent. In more basic terms, stabilizers improve the uniformity and smoothness of the finished product and enhance the product's resistance to melting. Additionally, stabilizers retard the formation of ice crystals. As such, if a gum stabilizer were to be excluded from the formulation, the resultant frozen product would be harder than optimum for a typical ice pop frozen confection or frozen beverage. Additionally, the end product would likely possess inferior organoleptic properties. The stabilizer employed can be one or a combination of the following gum stabilizers including but not limited to locust bean gum, agar-agar, xanthan gum, cellulose gum, algin-sodium alginate, propylene glycol alginate, gum acacia, guar seed gum, pectin, gum karaya, cat gum, gum tragacanth, and carrageenan. The gum stabilizer is present in an amount ranging from 0.001% to 1.0% by weight, more preferably between 0.01% to 0.5% by weight, and most preferably between 0.1% to 0.4% by weight. The precise amount used depends on the percent sugars and alcohols in the mixture as well as the organoleptic properties sought. Too much stabilizer yields a product that will be considered too rubbery, too little and the product is too hard and coarse.

An emulsifier is used to affect the texture of the food product. Specifically, an emulsifier helps mix ingredients that normally would separate, such as oil and water. To compare an emulsifier to a stabilizer, once blended with an emulsifier into an emulsion, that is, a suspension of small globules of one liquid in a second liquid with which the first will not mix, the addition of a stabilizer will prevent these ingredients from separating again. An emulsifier may be employed and can be one or a combination of the following emulsifiers including but not limited to lecithin, mono- and diglycerides, and polysorbates. The emulsifier is present in an amount ranging from 0% to 3.0% by weight, more preferably between 0.1% to 2.0% by weight, and most preferably between 0.5% to 1.0% by weight. By varying the types and amount of emulsifier employed in conjunction with varying the types and amount of stabilizer used, the organoleptic properties of the food product can vary dramatically yet be equally pleasing.

Flavoring formulations can include a combination of essential oils, natural extracts, juice concentrates, artificial flavorings, and other flavoring techniques. Flavorings typically account for no more than 2.0% by weight, more preferably less than 1.0% by weight, and most preferably less than 0.5% by weight.

Acidulants may be used in designing the flavoring characteristics as well as influencing the pH balance. The change in pH associated with the use of an acidulant also impacts the effectiveness of the stabilizer to achieve optimum development of gel character and strength. Citric acid is the preferred acidulant because of its high solubility and pleasant sour taste, but other acidulants can also be employed such as malic acid, tartaric acid, fumaric acid, phosphoric acid among others. The acidulant chosen will preferably be in an amount ranging from 0.1% to 4.0% by weight, more preferably between 0.4% to 3.0% by weight and most preferably between 1.0% and 2.0% by weight. How much acidulant to use depends on the sweetness of the formulation.

The present invention relates to method for obtaining a food product which may comprise the steps of: three-dimensionally printing a mold which may comprise a plurality of base units at a desired length and a desired width, filling the mold with chocolate, a cookie, fruit, frozen water, frozen yogurt, gelatin, ice cream, kombucha, or a wafer, optionally freezing, chilling, or heating the mold to set the food product, and removing the finished food product from the mold. The method may further comprise the step of inserting the supporting member into the mold prior to the optional step of freezing, chilling, or heating the mold to set the food product. Advantageously, the mold may comprise an upper half and a lower half.

Although the present invention and its advantages have been described in detail, it should be understood that various changes, substitutions and alterations can be made herein without departing from the spirit and scope of the invention as defined in the appended claims.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A food product comprising:
a plurality of base units, wherein a base unit comprises a polyhedron or a curved geometric shape having a top, a bottom, and a middle;
wherein the individual base units are connected on at least one side to another base unit; and
the connection between the base units is shearable.

2. The food product of claim 1, wherein the base unit comprises a polyhedron.

3. The food product of claim 2,
wherein the top comprises a top pyramid having a plurality of triangular faces and a base having a plurality of sides equal to the number of triangular faces that forms an upper base of a prism;
wherein the bottom comprises a bottom pyramid having a plurality of triangular faces and a base having a plurality of sides equal to the number of triangular faces that forms a lower base of the prism; and
wherein the middle comprises the prism having the upper base, the lower base, and a plurality of faces equal to the number of triangular faces of either the top pyramid or the bottom pyramid;

4. The food product of claim 3, wherein the top pyramid has six triangular faces, the bottom pyramid has six triangular faces, the upper base of the prism has six sides, the lower base of the prism has six sides, and wherein the prism has six faces.

5. The food product of claim 2, wherein the polyhedron is an elongated hexagonal bipyramid.

6. The food product of claim 1, whose width comprises at least two connected base units.

7. The food product of claim 1, whose length comprises at least two connected base units.

8. The food product of claim 1, whose width comprises at least three connected base units and whose length comprises at least five connected base units.

9. The food product of claim 2, illustrated as FIG. 1 or FIGS. 3A-3F.

10. The food product of claim 1, wherein the base unit comprises a curved geometric shape.

11. The food product of claim 10, illustrated as FIGS. 4A-4D.

12. The food product of claim 1, wherein the base units comprise chocolate, a cookie, fruit, frozen water, frozen yogurt, gelatin, ice cream, kombucha or a wafer.

13. The food product of claim 12, wherein the food product is a frozen confection.

14. The food product of claim 13, wherein the frozen confection is an ice pop, freezer pop, ice lolly, ice block, icy pole, ice drop, paleta or ice cream bar.

15. The food product of claim 12, wherein the kombucha is flavored or unflavored and optionally mixed with fruit.

16. The frozen confection of claim 13, illustrated as FIGS. 5A-5D.

17. A method for obtaining a food product comprising the steps of: three-dimensionally printing a mold comprising a plurality of base units at a desired length and a desired width, filling the mold with chocolate, a cookie, fruit, frozen water, frozen yogurt, gelatin, ice cream, kombucha or a wafer, optionally freezing, chilling, or heating the mold to set the food product, and removing the finished food product from the mold.

18. The method of claim 17, further comprising the step of inserting the supporting member into the mold prior to the optional step of freezing, chilling, or heating the mold to set the food product.

19. The method of claim 18, wherein the mold comprises an upper half and a lower half.

20. The method of claim 19, wherein the mold is illustrated in FIG. 2.
